(19) United States
(12) Patent Application Publication
(10) Pub. No.: US 2022/0365604 A1
(43) Pub. Date: Nov. 17, 2022

(54) COMPUTING DEVICE AND METHOD FOR TRACKING OBJECTS

(71) Applicant: Telefonaktiebolaget LM Ericsson (publ), Stockholm (SE)

(72) Inventors: Tommy Arngren, SÖDRA SUNDERBYN (SE); Jonas Pettersson, LULEÅ (SE); Peter Ökvist, LULEÅ (SE)

(21) Appl. No.: 17/623,311

(22) PCT Filed: Jul. 3, 2019
(86) PCT No.: PCT/SE2019/050664

§ 371 Date: Dec. 28, 2021

(51) Int. Cl. G06F 3/01; G06F 1/16; G06V 40/20; G06V 40/10; G06V 20/64; H04B 17/318

(52) U.S. Cl. CPC G06F 3/017; G06F 3/011; G06F 1/163; G06V 40/20; G06V 40/10; G06V 20/64; H04B 17/318

(57) ABSTRACT

A computing device for tracking objects is provided. The computing device comprises a positioning sensor, a wireless network interface, and a processing circuit which causes the computing device to be operative to detect that an object is gripped by a user carrying the computing device, identify the object, and update information pertaining to the object in a database accessible by multiple computing devices. The information comprises an identifier associated with the object, an identifier associated with the user, and position information identifying the object as being co-located with the user. The computing device is further operative to detect that the object is released by the user, and in response thereto, update the position information in the database with a position of the computing device when the object was released by the user.

### TECHNICAL FIELD

The invention relates to a computing device for tracking objects, a method of tracking objects performed by a computing device, a corresponding computer program, a corresponding computer-readable storage medium, and a corresponding data carrier signal.

### BACKGROUND

People may have difficulties in keeping track of objects such as electronic devices (e.g., mobile phones, tablet computers, or the like), watches, keys, wallets, remote controls, tools, or any other types of everyday items in general, which can be picked up, i.e., gripped with a hand of a person using the object (the user), carried by the user, and subsequently released by the user at a potentially different location.

There are different solutions to assist people in finding lost or displaced objects. For instance, battery-powered tracking devices are known which can be attached to objects such as wallets or keys, and which are based on short-range radio signals, e.g., Bluetooth. Further, Apple's “Find My iPhone” app can be used for locating iOS devices by retrieving position information from iOS devices which are connected to the Internet.

### SUMMARY

It is an object of the invention to provide an improved alternative to the above techniques and prior art.

More specifically, it is an object of the invention to provide improved solutions for tracking objects such as electronic devices (e.g., mobile phones, tablet computers, or the like), watches, keys, wallets, remote controls, tools, or any other types of everyday items in general, which can be picked up, i.e., gripped with a hand of a person using the object (the user), carried by the user, and released by the user at a potentially different location.

These and other objects of the invention are achieved by means of different aspects of the invention, as defined by the independent claims. Embodiments of the invention are characterized by the dependent claims.

According to a first aspect of the invention, a computing device for tracking objects is provided. The computing device comprises a positioning sensor, a wireless network interface, and a processing circuit. The processing circuit causes the computing device to be operative to detect that an object is gripped by a user carrying the computing device, and to identify the object. The computing device is further operative to update information pertaining to the object in a database accessible by multiple computing devices. The information comprises an identifier associated with the object, an identifier associated with the user, and position information identifying the object as being co-located with the user. The computing device is further operative to detect that the object is released by the user, and in response thereto, update the position information with a position of the computing device when the object was released by the user.

According to a second aspect of the invention, a method of tracking objects is provided. The method is performed by a computing device and comprises detecting that an object is gripped by a user carrying the computing device, and identifying the object. The method further comprises updating information pertaining to the object in a database accessible by multiple computing devices. The information comprises an identifier associated with the object, an identifier associated with the user, and position information identifying the object as being co-located with the user. The method further comprises detecting that the object is released by the user, and in response thereto, updating the position information in the database with a position of the computing device when the object was released by the user.

According to a third aspect of the invention, a computer program is provided. The computer program comprises instructions which, when the computer program is executed by a processor comprised in a computing device, cause the computing device to carry out the method according to the third aspect of the invention.

According to a fourth aspect of the invention, a computer-readable storage medium is provided. The computer-readable storage medium has stored thereon the computer program according to the third aspect of the invention.

According to a fifth aspect of the invention, a data carrier signal is provided. The data carrier signal carries the computer program according to the third aspect of the invention.

The invention makes use of an understanding that computing devices, in particular mobile communications devices which are carried by users, such as mobile phones, smartphones, tablet computers, Personal Digital Assistants (PDAs), Head-Mounted Displays (HMDs), or Augmented-Reality (AR) headsets, can be used for keeping track of objects which are picked up by their users at a location where the objects are currently located (by gripping the object with a hand), and subsequently released after the users have finished using them at a potentially different location. Information about the current location of an object, i.e., its position, is maintained in a database which is accessible by multiple computing devices, i.e., a shared database.

This is advantageous in that multiple computing devices which are carried by their users can share information about the current positions of one or more objects, allowing users to locate an object which there are interested in finding and which may be in use by another user or which has been placed at a position where it has been released by the user or another user.

Even though advantages of the invention have in some cases been described with reference to embodiments of the first aspect of the invention, corresponding reasoning applies to embodiments of other aspects of the invention.

Further objectives of, features of, and advantages with, the invention will become apparent when studying the following detailed disclosure, the drawings and the appended claims. Those skilled in the art realize that different features of the invention can be combined to create embodiments other than those described in the following.

### BRIEF DESCRIPTION OF THE DRAWINGS

The above, as well as additional objects, features and advantages of the invention, will be better understood through the following illustrative and non-limiting detailed description of embodiments of the invention, with reference to the appended drawings, in which:

FIG. 1 illustrates a user wearing an AR headset and gripping objects, in accordance with embodiments of the invention.

FIG. 2 illustrates an image captured by a camera worn by the user, in accordance with embodiments of the invention.

FIG. 3 shows a sequence diagram illustrating tracking of objects using one or more computing devices, in accordance with embodiments of the invention.

FIG. 4 shows an embodiment of the processing circuit comprised in the computing device for tracking objects, in accordance with embodiments of the invention.

FIG. 5 shows a flow chart illustrating a method of tracking objects, the method performed by a computing device, in accordance with embodiments of the invention.

All the figures are schematic, not necessarily to scale, and generally only show parts which are necessary in order to elucidate the invention, wherein other parts may be omitted or merely suggested.

### DETAILED DESCRIPTION

The invention will now be described more fully herein after with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

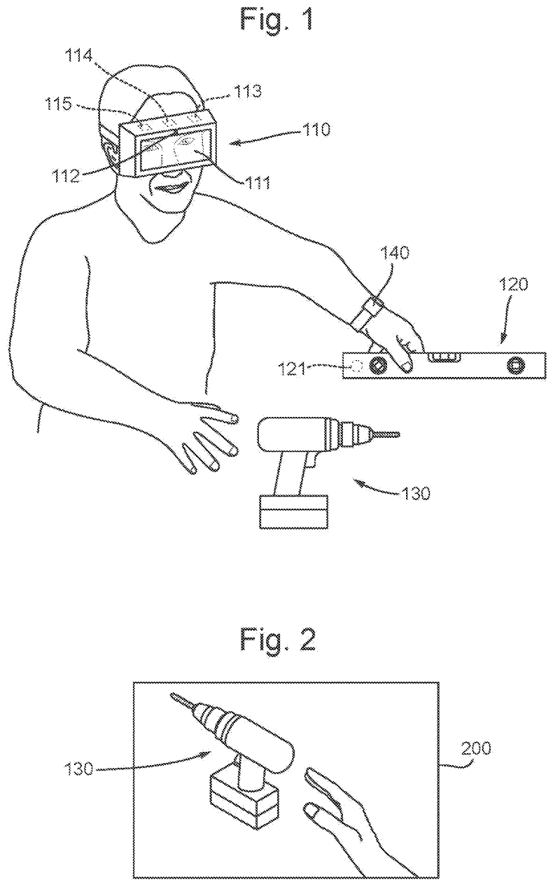

In the following, embodiments of the computing device 110 for tracking objects are described with reference to FIG. 1, in which the computing device 110 is illustrated as an AR headset, or HMD, which is worn by a user gripping one or more objects 120 and 130 with his/her hand or hands. In FIG. 1, the objects which are gripped by the user are illustrated as tools, a spirit level 120 which the user grips with the left hand, and a battery-powered drill 130 which the user is about to grip with the right hand. It will be appreciated that embodiments of the invention are not limited to the specific types of objects which are described throughout this disclosure, but may be envisaged to be used for tracking any kinds of objects such as electronic devices (e.g., mobile phones, tablet computers, or the like), watches, keys, wallets, remote controls, tools, or any other types of everyday items in general, which can be picked up, i.e., gripped with a hand of the user carrying the computing device 110, and subsequently released by the user. The location where an object is released, i.e., it's position, may potentially be different than the position at which the user has picked-up the object. Accordingly, there arises a need to assist users in locating objects which they, or others, have used and placed somewhere.

The computing device 110 comprises a positioning sensor 113, a wireless network interface 114, and a processing circuit 115. If the computing device is embodied as an optical AR headset or HMD 110 as is illustrated in FIG. 1, it may further comprise a see-through display 111 through which the user wearing the AR headset can view the rea-world scene, i.e., the physical world, in front of the user, and a camera 112 which is operative to capture images of the real-world scene in front of the user. The captured images, which may be still images or video sequences, may be used for generating a 3D model of the physical world around the user. Alternatively, if the computing device 110 is a non-optical HMD, i.e., the images captured by the camera 112 may be displayed to the user on a display provided on the inside of the computing device 110 (instead of see-through display 111). Even further, the computing device 110 may also be embodied as a mobile phone or smartphone which is fixated to the head of the user using an arrangement comprising additional optical components, such as a half-see-through mirror, which enables the user to view the real-world scene and to project images displayed by the smartphone towards the eyes of the user. An example of such an arrangement is the HoloKit cardboard headset.

The positioning sensor 113 is operative to determine a current position of the computing device 110, and accordingly that of its user carrying the computing device 110. It may either be based on the Global Positioning System (GPS), the Global Navigation Satellite System (GNSS), China's BeiDou Navigation Satellite System (BDS), GLONASS, or Galileo, or may receive position information via the wireless network interface 114, e.g., from a positioning server. The position information may, e.g., be based on radio triangulation, radio fingerprinting, or crowd-sourced identifiers which are associated with known positions of access points of wireless communications networks (e.g., cell-IDs or WLAN SSIDs). The current position of the computing device 110 may, e.g., be made available via an Application Programming Interface (API) provided by an operating system of the computing device 110.

The wireless network interface 114 is a circuit which is operative to access a wireless communications network and thereby enable the computing device 110 to communicate, i.e., exchange data in either direction (uplink or downlink). The computing device may, e.g., exchange data with other computing devices which are similar to the computing device 110, or a database 150 which is accessible by multiple computing devices 110 and which is operative to maintain information pertaining to one or more objects, as is described further below. A yet a further alternative, the wireless network interface 114 may be operative to exchange data with one or more other communications devices of the user, such as a smartwatch 140 which is shown in FIG. 1. The wireless network interface 114 may comprise one or more of a cellular modem (e.g., GSM, UMTS, LTE, 5G, NR/NX), a WLAN/Wi-Fi modem, a Bluetooth modem, a Near-Field Communication (NFC) modem, or the like.

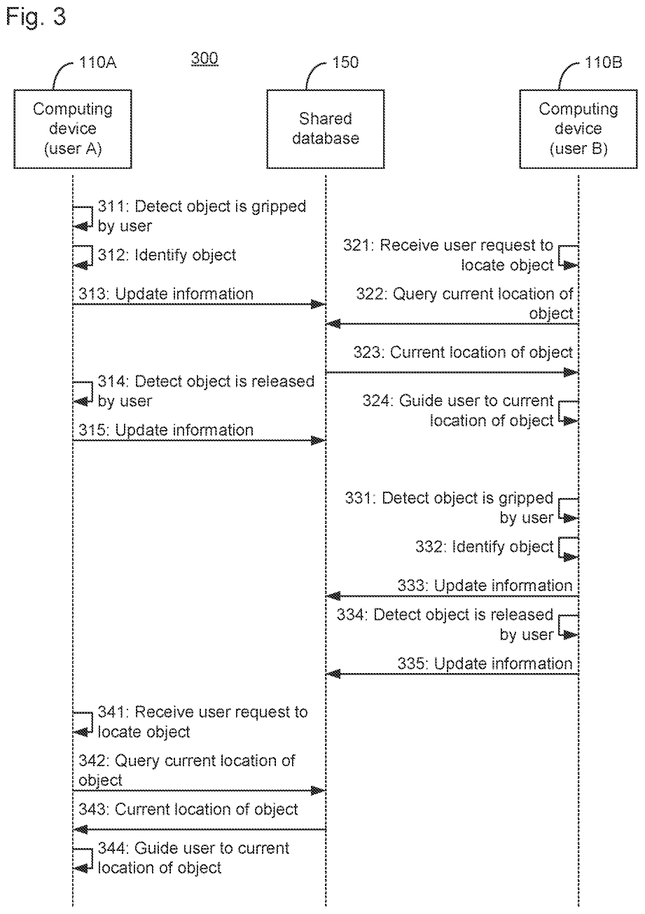

Embodiments of the computing device 110 are now described with further reference to FIG. 3, which shows a sequence diagram 300 illustrating tracking of objects using one or more computing devices 110A and 110B (collectively referred to as computing device(s) 110).

The processing circuit 115 causes the computing device 110 to be operative to detect 311/331 that an object is gripped by a user carrying the computing device 110, such as the spirit level 120 or the drill 130. For instance, the computing device 110 may be operative to detect 311/331 that an object is gripped by a user carrying the computing device 110 by detecting flexion of the fingers of a hand of the user, wherein the flexion of the fingers is characteristic of the hand gripping an object. The computing device 110 may, e.g., be operative to detect flexion of the fingers based on sensor data which is received from a sensor device which is worn close to the hand gripping the object. The sensor device may, e.g., be a smartwatch 140 or any other wearable device which is preferably worn close to the wrist and which comprises haptic sensors, motion sensors, and/or ultrasound sensor, which are operative to detect flexion of the fingers. For instance, McIntosh et al: have demonstrated hand-gesture recognition using ultrasound imaging (J. McIntosh, A. Marzo, M. Fraser, and C. Phillips, “EchoFlex: Hand Gesture Recognition using Ultrasound Imaging”, in Proceedings of the 2017 CHI Conference on Human Factors in Computing Systems, pages 1923-1934, ACM New York, 2017). Alternatively, the sensor device may be a haptic glove which is worn by the user. The sensor data is received by the computing device 110 via its wireless network interface 114, and is transmitted by the sensor device via a corresponding network interface comprised in the sensor device, e.g., a Bluetooth interface.

The computing device 110 may alternatively be operative to detect 311/331 that an object is gripped by a user carrying the computing device 110 by performing image analysis on one or more images captured by a camera worn by the user. This may, e.g., be a camera 112 which is integrated into an AR headset, or HMD, embodying the computing device 110, as is illustrated in FIG. 1. Alternatively, the camera may be integrated into a helmet worn by the user, or be fixated to the user's body, e.g., a body camera. This type of image analysis for recognition of hand gestures is known in the art. In FIG. 2, an image 200 captured by the camera 112 integrated into the AR headset 110 illustrated in FIG. 1 is exemplified. This embodiment of the computing device 110 which relies on image analysis to detect that an object is gripped 311/331 by the user is based on an understanding that people typically gaze at objects they intend to grip. Accordingly, there is a high likelihood that an object which the user intends to grip, such as drill 130, is visible in the image 200 which is captured by the camera 112 worn by the user, as is illustrated in FIG. 2.

As a further alternative, the computing device 110 may be operative to detect 311/331 that an object is gripped by a user carrying the computing device 110 by evaluating a strength of a radio signal which is transmitted by the object. This is exemplified in FIG. 1, which illustrates the spirit level 120 as being provided with a Radio-Frequency Identification (RFID) sticker 121. The radio signal may alternatively be transmitted by any other type of radio transmitter which is comprised in the object or can be attached to an object. Preferably, the radio signal is a short-ranged radio signal, such as Bluetooth or NFC. For instance, car keys frequently incorporate radio transmitters used for unlocking a car. The radio signal which is transmitted by an object may, e.g., be received by the computing device 110, via the wireless network interface 114. Alternatively, the computing device 110 may be operative to evaluate a strength of a radio signal transmitted by the object based on data pertaining to the strength of the radio signal, which data is received from a receiver device worn close to the hand gripping the object and which has received the radio signal. For instance, this may be the smartwatch 140 or any other type of wearable communications device which is worn by the user, preferably close to the wrist. The detecting 311/331 that an object is gripped by the user may be achieved by concluding that an object is gripped if the signal strength of the received radio signal gradually increases (owing to the hand and the computing device 110, or the receiver device, approaching the object, such that the distance between them is gradually reduced and the received signal strength increases accordingly) and then becomes substantially constant (the hand has gripped the object, the distance between object and the computing device 110, or the receiver device, is substantially constant, as is the received signal strength).

The computing device 110 is further operative to identify 312/332 the object which is gripped 311/331 by the user. The computing device 110 may, e.g., be operative to identify 312/332 the object by performing object recognition on one or more images captured by a camera worn by the user, similar to what is described hereinbefore in relation to detecting that an object is gripped by the user. In particular, the camera may be the camera 112 which is integrated into an AR headset, or HMD, embodying the computing device 110, as is illustrated in FIG. 1. Alternatively, the camera may be integrated into a helmet worn by the user, or be fixated to the user's body, e.g., a body camera. Identifying 312/332 the object based on object recognition may be achieved using a machine-learning model which has been trained by classifying images of objects which are frequently used by, and/or are known to, the user. Alternatively, a generic machine-learning model or a generic database with images of objects, and which can be accessed or retrieved by the computing device 110, may be used. As yet a further alternative, identifying the object based on analyzing an image captured by a camera worn by the user may also rely on fiducial markers of objects, e.g., stickers or labels which are attached to objects. Such fiducial markers may optionally comprise optically readable codes, such as bar codes or QR codes.

The computing device 110 may alternatively be operative to identify 312/332 the object based on a radio signal which is transmitted by the object, similar to what is described hereinbefore in relation to detecting that an object is gripped by the user. In particular, the object may be provided with an RFID sticker, such as RFID sticker 121, or any other type of radio transmitter which is comprised in the object or can be attached to an object and which is transmitting a distinct code, such as a MAC address or any other unique identifier associated with the radio transmitter or object, or a distinct radio-signal pattern. Preferably, the radio signal is a short-ranged radio signal, such as Bluetooth or NFC.

The computing device 110 is further operative to update 313/333 information pertaining to the object in a database 150 which is accessible by multiple computing devices 110. The database 150, which is also referred to as a shared database, may, e.g., be maintained in an application server, an edge server, or a cloud storage, which is accessible by the computing devices 110 through one or more wireless communications network to which the computing devices 110 are connected via their wireless network interfaces 114. The computing device 110 is operative to update 313/333 the information pertaining to the object by transmitting information via its wireless network interface 114 using a suitable protocol, e.g., one or more of the Hypertext Transfer Protocol (HTTP), the Transmission Control Protocol/Internet Protocol (TCP/IP) suite, the Constrained Application Protocol (CoAP), the User Datagram Protocol (UDP), or the like. As an alternative the shared database 150 may be maintained in a local data storage, i.e., memory, of each of the multiple computing devices 110, which multiple local databases are continuously synchronized with each other, or with a master database which is maintained in an application server, an edge server, or a cloud storage. Synchronization is achieved by transmitting and/or receiving information via the wireless network interfaces 114 using a suitable protocol, as is described hereinbefore.

The information which is updated in the database 150 comprises an identifier which is associated with the object, an identifier which is associated with the user, and position information which identifies the object as being co-located with the user. The identifier which is associated with the object is preferably generated based a unique code or identifier which is obtained when the object is identified 312/332. Alternatively, an identifier which is associated with the object may be generated by the database 150, in particular if the object is not yet listed in the database 150 and a new database entry is created. The identifier which is associated with the user may, e.g., be a name, a user name, an account name, or a login name, of the user. Alternatively, the identifier which is associated with the user may be an identifier which is associated with the user's computing device 110, e.g., a MAC address of the computing device 110, a name associated with the computing device 110 (e.g., “Bob's iPhone”), or the like. The position information which identifies the object as being co-located with the user may, e.g., be an information field, or a flag, indicating that the object is co-located with the user who is identified by the identifier which is associated with the user (e.g., a Boolean flag). Alternatively, the position information which identifies the object as being co-located with the user may be the identifier which is associated with the user (e.g., “Bob”) of the computing device of the user (e.g., “Bob's iPhone”). Optionally, the computing device 110 may be operative to update 313/333 the position information identifying the object as being co-located with the user by recurrently updating the position information with a current position of the computing device 110 of the user who has gripped the object, which position information is acquired from the positioning sensor 113. The position information identifying the object as being co-located with the user may be updated 313/333 periodically, or in response to detecting that the position of the computing device, and thereby that of the user, has changed by more than a threshold distance.

The computing device 110 is further operative to detect 314/334 that the object is released by the user. This may be achieved in a similar way as is described hereinbefore in relation to detecting that an object is gripped by the user. For instance, the computing device 110 may be operative to detect 314/334 that the object is released by the user by detecting flexion of the fingers of a hand of the user, wherein the flexion of the fingers is characteristic of the hand releasing an object. The computing device 110 may, e.g., be operative to detect flexion of the fingers based on sensor data which is received from the sensor device which is worn close to the hand gripping the object, such as the smartwatch 140 or other wearable device worn close to the wrist and comprising haptic sensors, motion sensors, and/or ultrasound sensors, or a haptic glove worn by the user. The computing device 110 may alternatively be operative to detect 314/334 that the object is released by the user by performing image analysis on one or more images captured by a camera worn by the user, e.g., the camera 112 which is integrated into an AR headset, or HMD, embodying the computing device 110, as is illustrated in FIG. 1, or a camera which is integrated into a helmet worn by the user or which is fixated to the user's body, e.g., a body camera. Similar to what is described hereinbefore, this embodiment of the computing device 110 which relies on image analysis to detect that the object is released 314/334 by the user is based on an understanding that people typically gaze at objects they are about to release, by placing the object on a surface such as a table, a floor, a shelf, or the like. Accordingly, there is a high likelihood that an object which the user is about to release is visible in an image which is captured by the camera worn by the user, similar to image 200 which is shown in FIG. 2. As a further alternative, the computing device 110 may be operative to detect 314/334 that the object is released by the user by evaluating a strength of the radio signal which is transmitted by the object. The detecting 314/334 that the object is released may be achieved by concluding that the signal strength of the received radio signal suddenly decreases owing to a sudden decrease of the distance between the object and the computing device 110, or the receiver device, when the object is released by the user. As yet a further alternative, the computing device 110 may be operative to detect 314/334 that the object is released by the user by analyzing an audio signal which is captured by a microphone comprised in the computing device 110, or by a microphone which is comprised in the smartwatch 140 or other wearable audio-recording device which is worn by the user. This may be achieved by detecting a sound which is characteristic of an object being placed on a surface, in particular a hard surface, using a trained machine-learning model.

The processing circuit 115 causes the computing device 110 to be further operative to update 315/335 the position information in the database 150 in response to detecting 314/334 that the object is released by the user. The position information in the database 150 is updated 315/335 with a position of the computing device 110 when the object was released by the user. The position information is obtained from the positioning sensor 113. Similar to what is described hereinbefore, the computing device 110 may be operative to update 315/335 the position information by transmitting information to the database 150 via its wireless network interface 114 using a suitable protocol, e.g., one or more of HTTP, TCP/IP, CoAP, UDP, or the like. As an alternative, if the database 150 is maintained in a local data storage of each of the multiple computing devices 110, the local databases 150 are continuously synchronized with each other, or with a master database which is maintained in an application server, an edge server, or a cloud storage, by transmitting information via the wireless network interfaces 114 using a suitable protocol.

Optionally, the computing device 110 may further be operative to receive 321/341 a request from the user to locate an object, to query 322/342 the database 150 to retrieve 323/343 a current position of the object, and to guide 324/344 the user to the current position of the object. The request from the user may, e.g., be received as a spoken instructions (e.g., “Find spirit level.”) which is captured by a microphone comprised in the computing device 110, and subjected to speech recognition, or via a graphical user interface through which the user interacts with the computing device 110. For instance, the computing device 110 may be operative to display a list of objects which currently are listed in the database 150 on a display of the computing device 110, from which list the user may select an object which he/she wishes to locate. The list of objects which currently are listed in the database 150 may be retrieved by querying the database 150 via the wireless network interface 114.

With reference to FIG. 3, different scenarios are described which may arise when users of computing devices, such as the computing devices 110A and 110B, wish to locate an object. For instance, the user (“user A”) of the computing device 110A may request 341 to locate an object which he/she has previously gripped 311 and released 314. This, e.g., may the case if user A has forgotten where he/she has placed the object. It may also be the case that another user (“user B”) of the computing device 110B has gripped 331 and subsequently released 334 the object after it has been released 314 by user A, such that user A is not aware of the current location (position) of the object. It may also be the case that the object is currently in use by user A, i.e., it has been gripped 311 but not yet released 314 by user A, and user B requests 321 to locate the object.

The computing device 110 may be operative to guide 324/344 the user to the current position of the object by displaying one or more cues guiding the user to the current position of the object. For instance, if the computing device 110 is embodied by an AR headset as is illustrated in FIG. 1, it may be operative to display arrows on the see-through display 111 which point in the direction of the current position of the object, in particular if the object is not visible in the field-of-the view of the AR headset, i.e., if the object is currently located in the real-world scene where it is not visible to the user. Alternatively, if the object is within the field-of-view of the AR headset 110, the object may be highlighted, e.g., by displaying a circle around the object, or any other graphical marker close to the object.

Alternatively, the computing device 110 may be operative to guide 324/344 the user to the current position of the object by emitting an audible sound guiding the user to the current position of the object. In particular, the emitted audible sound may be varied to reflect a distance between the user and the current position of the object while the user is moving around to locate the object. For instance, a volume or a frequency of the audible sound may increase with decreasing distance. If the audible sound comprises repetitive beeps, the duration in-between beeps may be shortened to reflect a decrease in distance, similar to a metal detector.

As yet a further alternative, the computing device 110 may be operative, if the current position of the object is indicated as being co-located with another user, to guide 324/344 the user to the current position of the object by notifying the user that the object is currently co-located with the other user. This may, e.g., be achieved by providing an audible instruction to the user (e.g., “The spirit level is used by Bob.”), or by displaying corresponding information to the user (e.g., “The spirit level is used by Bob.”). Similar to what is described hereinbefore, the computing device 110 may be operative to guide the user to the object at its current position even if it is in use by another user, e.g., by displaying one or more cues or by emitting audible sound guiding the user requesting to locate the object to the user who has gripped the object.

Although embodiments of the computing device have in some cases been described with reference to the AR headset 110 illustrated in FIG. 1, also referred to as HMD, alternative embodiments of the computing device for tracking objects may easily be envisaged. For instance, the computing device for tracking objects may be a mobile phone, a smartphone, a tablet computer, or as a Personal Digital Assistant (PDA).

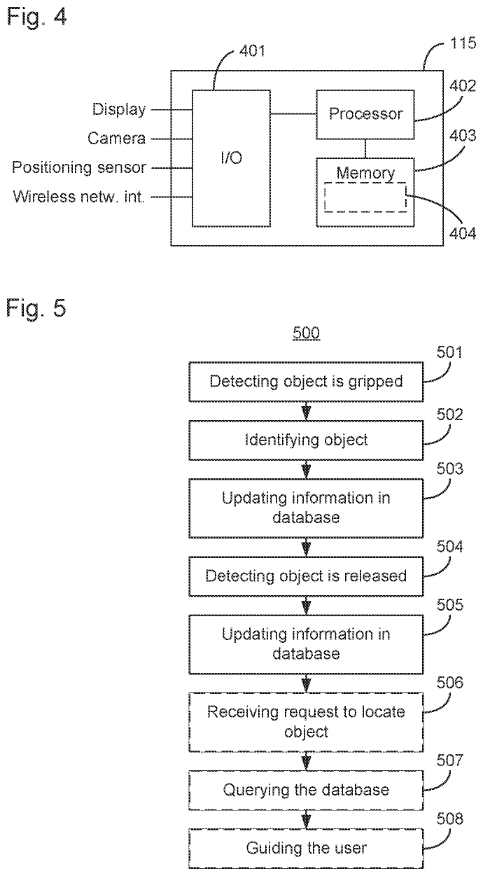

In the following, embodiments of the processing circuit 115 comprised in the computing device for tracking objects, such as the computing device 110, are described with reference to FIG. 4. The processing circuit 115 may comprise one or more processors 402, such as Central Processing Units (CPUs), microprocessors, application-specific processors, Graphics Processing Units (GPUs), and Digital Signal Processors (DSPs) including image processors, or a combination thereof, and a memory 403 comprising a computer program 404 comprising instructions. When executed by the processor(s) 402, the computer program 404 causes the computing device 110 to perform in accordance with embodiments of the invention described herein. The memory 403 may, e.g., be a Random-Access Memory (RAM), a Read-Only Memory (ROM), a Flash memory, or the like. The computer program 404 may be downloaded to the memory 403 by means of the wireless network interface 114, as a data carrier signal carrying the computer program 404. The processor(s) 402 may further comprise one or more Application-Specific Integrated Circuits (ASICs), Field-Programmable Gate Arrays (FPGAs), or the like, which in cooperation with, or as an alternative to, the computer program 404 are operative to cause the computing device 110 to perform in accordance with embodiments of the invention described herein. In addition, the processing circuit 115 comprises one or more interface circuits 401 (“I/O” in FIG. 4) for controlling and/or receiving information from other components comprised in the computing device 110, such as the display 111, the camera 112, the positioning sensor 113, the wireless network interface 114, and any additional components which are comprised in the computing device 110, e.g., a microphone, a loudspeaker, or the like. The interface(s) 401 may be implemented by any kind of electronic circuitry, e.g., any one, or a combination of, analogue electronic circuitry, digital electronic circuitry, and processing circuits executing a suitable computer program, i.e., software.

In the following, embodiments of the method of tracking objects are described with reference to FIG. 5. The method 500 is performed by a computing device 110 and comprises detecting 501 that an object is gripped by a user carrying the computing device, and identifying 502 the object. The method 500 further comprises updating 503 information pertaining to the object in a database accessible by multiple computing devices. The information comprises an identifier associated with the object, an identifier associated with the user, and position information identifying the object as being co-located with the user. The method 500 further comprises detecting 504 that the object is released by the user, and in response thereto, updating 505 the position information in the database with a position of the computing device when the object was released by the user.

The detecting 501 that an object is gripped by a user carrying the computing device may comprise detecting flexion of the fingers of a hand of the user which is characteristic of the hand gripping an object. Optionally, the flexion of the fingers is detected based on sensor data received from a sensor device worn close to the hand gripping the object.

The detecting 501 that an object is gripped by a user carrying the computing device may alternatively comprise performing image analysis on an image captured by a camera worn by the user.

The detecting 501 that an object is gripped by a user carrying the computing device may alternatively comprise evaluating a strength of a radio signal transmitted by the object. Optionally, the strength of a radio signal transmitted by the object is evaluated based on data pertaining to the strength of the radio signal, which data is received from a receiver device worn close to the hand gripping the object and which has received the radio signal.

The identifying 502 the object may comprise performing object recognition on an image captured by a camera worn by the user.

Alternatively, the object may be identified 502 based on a radio signal transmitted by the object.

The updating 503 the position information identifying the object as being co-located with the user may comprise recurrently updating the position information with a current position of the computing device.

The method 500 may further comprise receiving 506 a request from the user to locate the object, querying 507 the database to retrieve a current position of the object, and guiding 508 the user to the current position of the object. The guiding 508 the user to the current position of the object may comprise displaying one or more cues guiding the user to the current position of the object. The guiding 508 the user to the current position of the object may alternatively comprise emitting audible sound guiding the user to the current position of the object. If the current position of the object is indicated as being co-located with another user, the guiding 508 the user to the current position of the object may alternatively comprise notifying the user that the object is currently co-located with the other user.

It will be appreciated that the method 500 may comprise additional, alternative, or modified, steps in accordance with what is described throughout this disclosure. An embodiment of the method 500 may be implemented as the computer program 404 comprising instructions which, when executed by the one or more processor(s) 402 comprised in the computing device 110, cause the computing device 110 to perform in accordance with embodiments of the invention described herein.

The person skilled in the art realizes that the invention by no means is limited to the embodiments described above. On the contrary, many modifications and variations are possible within the scope of the appended claims.

1. A computing device for tracking objects, the computing device comprising:
a positioning sensor,
a wireless network interface, and
a processing circuit causing the computing device to be operative to:
detect that an object is gripped by a user carrying the computing device,
identify the object,
update information pertaining to the object in a database accessible by multiple computing devices, the information comprising an identifier associated with the object, an identifier associated with the user, and position information identifying the object as being co-located with the user,
detect that the object is released by the user, and
in response thereto, update the position information in the database with a position of the computing device when the object was released by the user.

2. The computing device according to claim 1, operative to detect that an object is gripped by a user carrying the computing device by detecting flexion of the fingers of a hand of the user which is characteristic of the hand gripping an object.

3. The computing device according to claim 2, operative to detect flexion of the fingers based on sensor data received from a sensor device worn close to the hand gripping the object.

4. The computing device according to claim 1, operative to detect that an object is gripped by a user carrying the computing device by performing image analysis on an image captured by a camera worn by the user.

5. The computing device according to claim 1, operative to detect that an object is gripped by a user carrying the computing device by evaluating a strength of a radio signal transmitted by the object.

6. The computing device according to claim 5, operative to evaluate a strength of a radio signal transmitted by the object based on data pertaining to the strength of the radio signal, which data is received from a receiver device worn close to the hand gripping the object and which has received the radio signal.

7. The computing device according to claim 1, operative to identify the object by performing object recognition on an image captured by a camera worn by the user.

8. The computing device according to claim 1, operative to identify the object based on a radio signal transmitted by the object.

9. The computing device according to claim 1, operative to update the position information identifying the object as being co-located with the user by recurrently updating the position information with a current position of the computing device.

10. The computing device according to claim 1, further operative to:
receive a request from the user to locate the object,
query the database to retrieve a current position of the object, and
guide the user to the current position of the object.

11. The computing device according to claim 10, operative to guide the user to the current position of the object by displaying one or more cues guiding the user to the current position of the object.

12. The computing device according to claim 10, operative to guide the user to the current position of the object by emitting audible sound guiding the user to the current position of the object.

13. The computing device according to claim 10, operative, if the current position of the object is indicated as being co-located with another user, to guide the user to the current position of the object by notifying the user that the object is currently co-located with the other user.

14. The computing device according to claim 1, being any of a mobile phone, a smartphone, a tablet computer, a Personal Digital Assistant, PDA, a Head-Mounted Display, HMD, and an Augmented-Reality, AR, headset.

15. A method of tracking objects, performed by a computing device, the method comprising:
detecting that an object is gripped by a user carrying the computing device, identifying the object,
updating information pertaining to the object in a database accessible by multiple computing devices, the information comprising an identifier associated with the object, an identifier associated with the user, and position information identifying the object as being co-located with the user,
detecting that the object is released by the user, and
in response thereto, updating the position information in the database with a position of the computing device when the object was released by the user.

16. The method according to claim 15, the detecting that an object is gripped by a user carrying the computing device comprising detecting flexion of the fingers of a hand of the user which is characteristic of the hand gripping an object.

17. The method according to claim 16, wherein the flexion of the fingers is detected based on sensor data received from a sensor device worn close to the hand gripping the object.

18. The method according to claim 15, the detecting that an object is gripped by a user carrying the computing device comprising performing image analysis on an image captured by a camera worn by the user.

19. The method according to claim 15, the detecting that an object is gripped by a user carrying the computing device comprising evaluating a strength of a radio signal transmitted by the object.

20. The method according to claim 19, wherein the strength of a radio signal transmitted by the object is evaluated based on data pertaining to the strength of the radio signal, which data is received from a receiver device worn close to the hand gripping the object and which has received the radio signal.

21. The method according to claim 15, the identifying the object comprising performing object recognition on an image captured by a camera worn by the user.

22. The method according to claim 15, wherein the object is identified based on a radio signal transmitted by the object.

23. The method according to claim 15, the updating the position information identifying the object as being co-located with the user comprising recurrently updating the position information with a current position of the computing device.

24. The method according to claim 1, further comprising:
receiving a request from the user to locate the object,
querying the database to retrieve a current position of the object, and
guiding the user to the current position of the object.

25.-30. (canceled)
